(19) United States
(12) Patent Application Publication
(10) Pub. No.: US 2007/0086868 A1
(43) Pub. Date: Apr. 19, 2007

(54) Vacuum clamp for supporting a tool

(76) Inventor: James D. Ray, Morgan Hill, CA (US)

Correspondence Address: LITMAN LAW OFFICES, LTD, PO BOX 15035, CRYSTAL CITY STATION, ARLINGTON, VA, 22215, US

(21) Appl. No.: 11/251,820

(22) Filed: Oct. 18, 2005

(51) Int. Cl. B23B 45/14

(52) U.S. Cl. 408/76

(57) ABSTRACT

The vacuum clamp for supporting a tool is a releasable support for holding a tool against a workpiece or work surface. A gasket is secured to a lower surface of a vacuum plate, and the gasket is adapted for forming a releasable vacuum seal with the work surface. The vacuum plate has a vacuum port formed therethrough, allowing air to be selectively removed from the chamber defined by the gasket, the vacuum plate and the work surface, thus securing the vacuum plate to the work surface by vacuum. A tool support is mounted on the upper surface of the vacuum plate for supporting the tool, and a plurality of spacers are further provided for adjustably spacing the vacuum plate from the work surface.

### BACKGROUND OF THE INVENTION

1. Field of the Invention

The present invention relates to a power tool accessories, and particularly to a vacuum clamp for supporting a tool, such as a core drill, on a workpiece.

2. Description of the Related Art

In building construction and other fields it is often necessary to drill a hole in a precise location. Drill presses and workbench clamps can be used when the workpiece itself is portable. However, sometimes the workpiece is not portable and the tool must be transported to the workpiece. Even experienced craftsmen have difficulty in supporting a power tool firmly enough to drill a hole in a precise location by hand. Similar problems are experienced in using other power tools, e.g., power saws. Although several portable guides have been developed for drills and saws, none have proved entirely satisfactory. Thus, a vacuum clamp for supporting a tool above a fixed workpiece and solving the aforementioned problems is desired.

### SUMMARY OF THE INVENTION

The vacuum clamp for supporting a tool is a releasable support for holding a tool against a workpiece or work surface. The clamp includes a gasket secured to a lower surface of a vacuum plate. The gasket is adapted for forming a releasable vacuum seal with the work surface. The vacuum plate has a vacuum port formed therethrough, allowing air to be selectively removed from the chamber defined by the gasket, the vacuum plate and the work surface, thus releasably and selectively securing the vacuum plate to the work surface by the vacuum thus formed.

The vacuum port includes a housing formed on the upper surface of the vacuum plate, to which a vacuum coupler or connector is attached. The connector is adapted for connection with an air hose, which is utilized to draw off the air within the chamber. The housing spaces the connector away from the upper surface of the vacuum plate, providing easy access to the user.

Further, a tool support is mounted on the upper surface of the vacuum plate for supporting the tool, and a plurality of adjustable spacers are further provided for adjustably spacing the vacuum plate from the work surface. The tool support may be a threaded rod upon which a power tool mounting plate may be mounted. The adjustable spacers contact the work surface and prevent potentially damaging overcompression of the gasket.

These and other features of the present invention will become readily apparent upon further review of the following specification and drawings.

### BRIEF DESCRIPTION OF THE DRAWINGS

FIG. 1 is an environmental, perspective view of a vacuum clamp for supporting a tool according to the present invention.

FIG. 2 is a side view of the vacuum clamp for supporting a tool according to the present invention.

FIG. 3 is a top view of the vacuum clamp for supporting a tool according to the present invention.

FIG. 4 is a bottom view of the vacuum clamp for supporting a tool according to the present invention.

Similar reference characters denote corresponding features consistently throughout the attached drawings.

### DETAILED DESCRIPTION OF THE PREFERRED EMBODIMENT

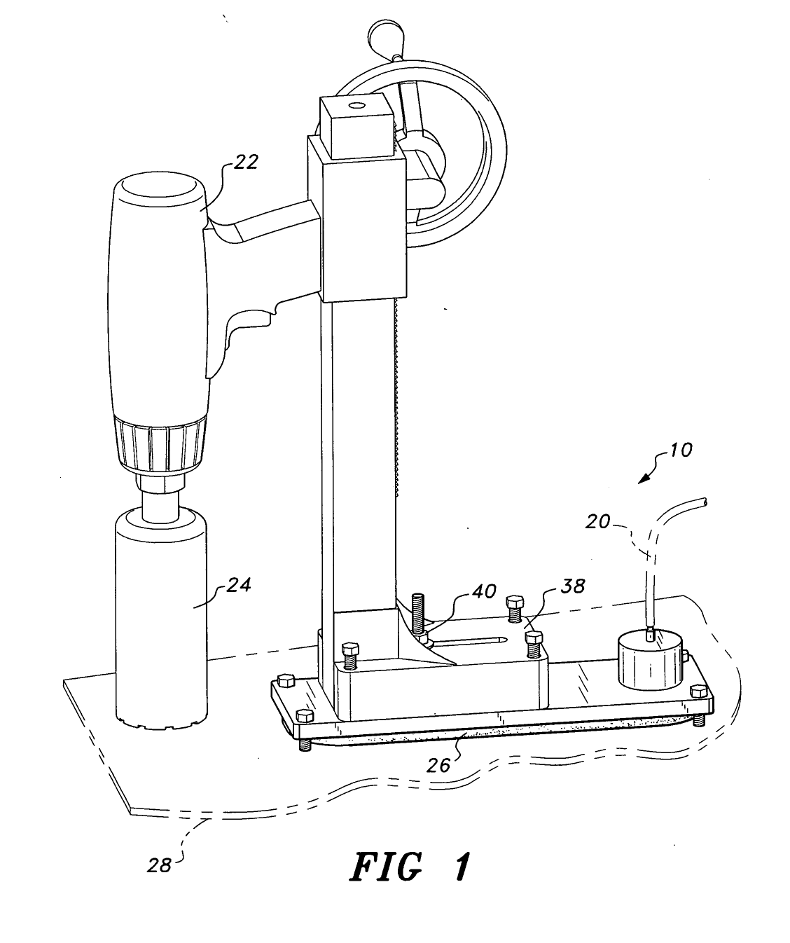

Now referring to FIG. 1, there is shown a vacuum clamp 10 for supporting a tool 22. Though illustrated as a conventional two-speed core drill mounted on a 2½ inch-wide square column, it should be understood that tool 22 may be any tool, such as a drill, saw, cutting tool or the like, which the user desires to make contact with a workpiece or work surface 28. Vacuum clamp 10 provides a stable support for tool 22, which is releasably secured to work surface 28 through vacuum, as will be described in detail below.

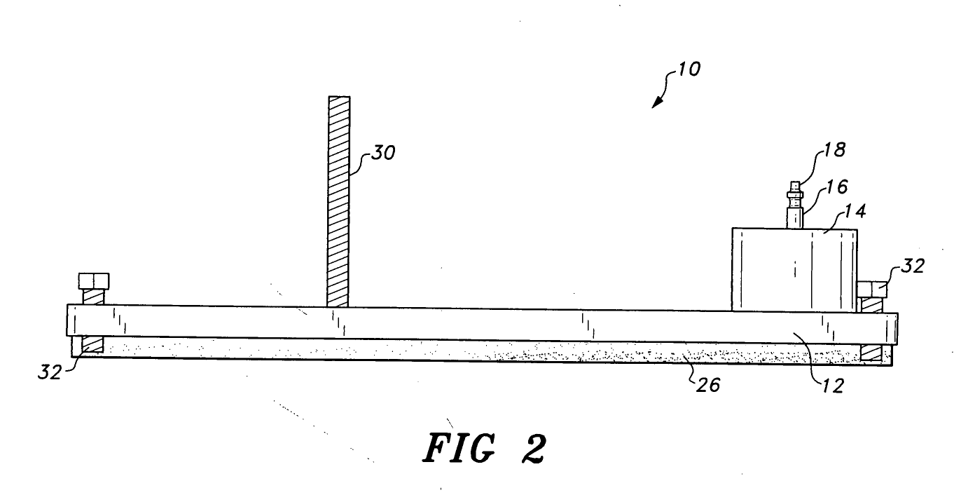

As best illustrated in FIG. 2, the vacuum clamp 10 includes a vacuum plate 12 having an upper surface and a lower surface. A gasket 26 is secured to the lower surface of vacuum plate 12 in a fluid-tight manner, and a tool support 30 is mounted on the upper surface of vacuum plate 12, and projects upwardly therefrom. The vacuum plate 12 may be a metal plate having any desired contour and dimensions. However, in the preferred embodiment, the vacuum plate 12 has a substantially rectangular contour having a length of approximately twenty inches, a width of approximately 6¼ inches and a thickness of approximately ¾ inches.

Gasket 26 is formed of flexible, resilient material, adapted for forming a vacuum seal with work surface 28. One such suitable material is neoprene. In the preferred embodiment, gasket 26 is a neoprene strip having a width of approximately one inch and a thickness of approximately ½ inch, the strip being formed into a closed loop having a circumference of approximately 46½ inches.

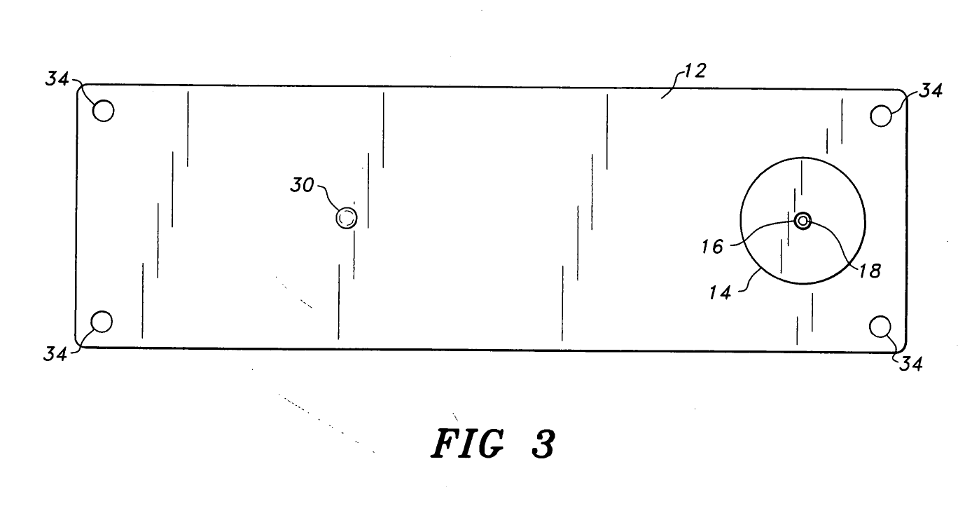

Tool support 30 is fixed to the upper surface of vacuum plate 12, and projects upwardly therefrom, with the longitudinal axis of tool support 30 being positioned substantially orthogonal to the plane of vacuum plate 12. The tool support 30 may be a threaded rod, as shown in FIGS. 1 and 2, and, in the preferred embodiment, has a height of approximately five inches and a diameter of approximately ½ inch. As shown in the top view of FIG. 3, tool support 30 is positioned substantially central to vacuum plate 12 in the lateral direction, and in the longitudinal direction, in the preferred embodiment, tool support 30 is positioned approximately 6½ inches from an edge of vacuum plate 12.

As shown in FIG. 1, tool support 30, e.g., a threaded stud, is adapted to receive a conventional tool mounting plate 38 thereon. Mounting plate 38 may have a threaded opening for receiving tool support 30, and a nut 40 may secure mounting plate 38 to tool support 30. The mounting plate 38 supports a column, and the tool 22 is mounted to the column. The cutting element 24 (e.g., a core drill bit) of tool 22 is supported directly above the workpiece or work surface 28, not above the vacuum plate 12.

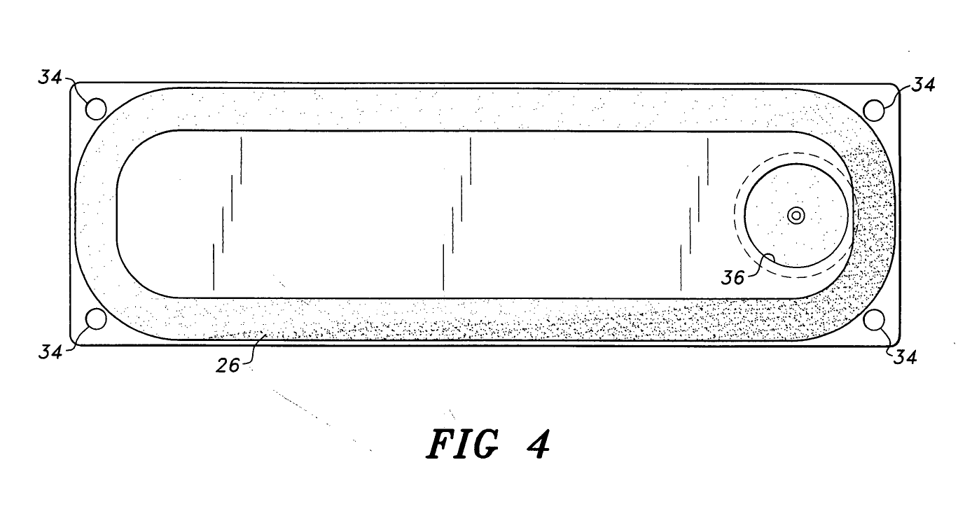

As shown in the bottom view of FIG. 4, a vacuum port 36 is formed through vacuum plate 12 and is positioned within the perimeter of gasket 26. When gasket 26 makes contact with work surface 28, as in FIG. 1, work surface 28, the inner wall of gasket 26 and the vacuum plate 12 form a chamber. In order to adhere vacuum clamp 10 to work surface 28, the air inside of the chamber is evacuated through vacuum port 36.

As shown in FIGS. 2 and 3, a housing 14 is formed on the upper surface of vacuum plate 12. Housing 14 is positioned over, and covers, vacuum port 36. In the preferred embodiment, housing 14 is cylindrical, as shown in the drawings, and has a diameter of approximately three inches and a height of approximately two inches. As best shown in the top view of FIG. 3, housing 14 is positioned substantially central to vacuum plate 12 in the lateral direction, and the center of housing 14 is positioned approximately 2½ inches from an edge of vacuum plate 12 opposite tool support 30.

Vacuum coupler or connector 16 having nipple 18 is in fluid connection with the chamber formed within the perimeter of gasket 26, via vacuum port 36. As shown in FIG. 1, connector 16 is provided for releasable connection with an air hose 20, which is connected to a vacuum pump for selectively removing the air from within the chamber. The positioning of connector 16 and housing 14 allows the connector 16 to be spaced apart from the upper surface of vacuum plate 12, allowing the user easier access to connector 18.

As shown in FIG. 3, threaded openings 34 are formed through vacuum plate 12, adjacent the periphery thereof. In the preferred embodiment, threaded openings 34 are positioned in each of the four corners of the substantially rectangular vacuum plate 12, and each is positioned approximately ¾ inches from either adjacent edge. Each threaded opening 34 is approximately ½ inch in diameter, and each threaded opening 34 receives a respective adjustable spacer 32 (as shown in FIG. 2). Adjustable spacers 32 may be screws, threaded bolts or the like, however, in the preferred embodiment, each adjustable spacer 32 is a ½ inch by 1½ inches grade 5 threaded bolt, also known as a leveling screw.

In operation, clamp 10 is positioned on work surface 28 and mounting plate 38 is secured to tool support 30. Tool 22 is attached to a support that can be raised and lowered on a column arising from the mounting plate 38 in the manner of a drill press, the support offsetting the tool 22 from vacuum plate 12 so that cutting element 24 of tool 22 contacts the workpiece or work surface 28 adjacent to vacuum plate 12. With gasket 26 contacting the work surface 28, air is evacuated via vacuum port 36 and drawn off by air hose 20, which is connected to connector 16. Gasket 26 is flexible, resilient and compressible and, thus, susceptible to deformation and damage if the generated vacuum compresses gasket 26 beyond its tolerance. Adjustable spacers 32 contact work surface 28 in order to position vacuum plate 12 away from work surface 28, thus preventing over-compression of gasket 26.

It is to be understood that the present invention is not limited to the embodiment described above, but encompasses any and all embodiments within the scope of the following claims.

I claim:

1. A vacuum clamp for supporting a tool, comprising:
a vacuum plate having an upper surface and a lower surface, the plate having a vacuum port and a plurality of threaded openings formed therethrough, the plurality of threaded openings being located adjacent to a periphery of the plate;
a gasket attached to the lower surface of the vacuum plate, the gasket being adapted for forming a vacuum seal against a workpiece;
a tool support mounted on the upper surface of the vacuum plate and projecting upwardly therefrom, the tool support being adapted for mounting of a tool thereon with a cutting element of the tool offset from the vacuum plate and supported directly above the workpiece;
a plurality of threaded spacers adjustably received within the plurality of threaded openings for providing a stop to prevent damage to the gasket; and
a vacuum coupler mounted to the vacuum port, the coupler being adapted for attachment to a vacuum source;
whereby a vacuum applied to the coupler seals the vacuum plate to the workpiece with the cutting element of the tool positioned directly above the workpiece adjacent the vacuum plate.

2. The vacuum clamp as recited in claim 1, further comprising a vacuum housing formed on said upper surface of said vacuum plate, the vacuum housing covering said vacuum port, said coupler being mounted on said housing in order to space said coupler from said vacuum plate.

3. The vacuum clamp for supporting a tool as recited in claim 1, wherein said tool support comprises a threaded rod.
